(19) United States
(12) Patent Application Publication
(10) Pub. No.: US 2025/0043837 A1
(43) Pub. Date: Feb. 6, 2025

(54) MOTOR VEHICLE DISC BRAKE WITH BELLOWS-TYPE SLEEVE FOR SEALING A BOLT GUIDE DEVICE AND BELLOWS-TYPE SLEEVE

(71) Applicant: Continental Automotive Technologies GmbH, Hannover (DE)

(72) Inventors: Norbert Leidecker, Eschborn (DE); Jochem Rausch, Essenheim (DE); Frederic Zimnoch, Roßdorf (DE); Stefanie Weise, Eschborn (DE); Christian Lankes, Riedstadt (DE)

(73) Assignee: Continental Automotive Technologies GmbH, Hannover (DE)

(21) Appl. No.: 18/717,537

(22) PCT Filed: Dec. 8, 2022
(86) PCT No.: PCT/EP2022/085052

§ 371 Date: Jun. 7, 2024

(30) Foreign Application Priority Data
Dec. 8, 2021 (EP) 21213176.7
May 4, 2022 (DE) 10 2022 204 394.4

(51) Int. Cl. F16D 55/2265

(52) U.S. Cl. CPC F16D 55/2265

(57) ABSTRACT

A motor vehicle disk brake has a sleeve which is manufactured from elastomer for the purpose of sealing a gap between the bolt and the brake holder. The sleeve has ribs lying against the bolt. The ribs are arranged parallel to the axis of the bolt and are odd in number. A release operation of the motor vehicle disk brake is assisted by the sleeve.

### TECHNICAL FIELD

A motor vehicle disk brake with a brake caliper housing, has a holding and guide system for rotationally fixedly and axially displaceably guiding the brake caliper housing.

### BACKGROUND

Sliding caliper brakes (also called floating caliper brakes) with guide bolts fixed to the brake housing in an axially movably arranged sliding guide arrangement in receiving bores of a brake holder fixed to the vehicle (what is referred to as a pin-slider design) are known in principle.

A hydraulic brake caliper of the exemplary type is disclosed in DE 695 06 897 T2. The bolt guide device of the sliding caliper or floating caliper (“pin-slider brake caliper”) is used to support the axially displaceably mounted cast metal brake caliper housing in relation to the brake holder under automotive complex stress (high application+braking forces, contamination, temperature range between a minimum of approx. −40° C. to a maximum of approx. 900° C., vibrations, etc.) as stably and as smoothly displaceable and also durable and with as little maintenance as possible, so that faults, such as misalignment or wedging, are prevented since this could cause brake failure.

DE 695 06 897 T2 illuminates a bolt guiding system, wherein, in addition to the first bore, a first seat is formed by the interior of a ring of elastomer material, which is accommodated in the extension of the first section of the first bore in such a way that it is spaced apart from said first section and that the entire length of the second bore has a diameter equal to the small diameter. Different guide sections in conjunction with two different bolt receiving bores in a brake holder in conjunction with two identically designed bolts are thus proposed. In addition, a first bore for receiving the guide bolt starts from a cylindrical shape, which is graduated, and into the interior of which a rigid ring with an inner diameter is pressed, said rigid ring covering and forming a first section. Moreover, in addition to the first bore, a first seat is formed by the interior of a ring of elastomer material which is accommodated in the extension of the first section of the first bore in such a way that it is adjacent to said first section and is spaced apart from the second section. Furthermore, the ring ensures a centering effect for the rod, enabling the latter to be brought into an optimum position and the vibrating of the brake caliper to be damped. The elastomeric ring has an integrally formed sleeve-like bellows that engages over a gap.

After release of a motor vehicle disk brake, for climate protection reasons a currently required special operational requirement is that a brake caliper housing be rapidly moved back with all of the friction linings to a brake release position/brake standby position, and with the friction linings being spaced apart as far as possible from a brake disk with a sufficient hairline gap distance to prevent undesirable residual grinding moments during normal driving. In particular, a neat restoring of the indirectly actuated friction lining of the sliding caliper brake of the type in question may be problematic in face of growing demands.

The hydraulic pin-slider disk brake according to the example of US 2022/0018406 A, which is not a prior publication, describes, for restoring purposes, a hydraulic brake piston with a roll-back seal in connection with a sleeve comprising a plurality of transverse ribs and transverse grooves extending transversely with respect to an axial bolt displacement direction.

The problem of presenting a further developed motor vehicle disk brake of the generic pin-slider type mentioned at the beginning (sliding caliper or floating caliper brake) with a restoring effect that is free from maintenance and is improved for an indirectly actuated friction lining with universal usability, i.e. independently of connection of an actuator.

### SUMMARY

In this context, an accompanying aim is to improve the production of brake components and the installation, in particular to develop a production and installation process of components economically, also in a manner appropriate for automation.

A disk brake is released in order to generate a release movement of a brake caliper housing from a brake holder 4. A sleeve is designed such that, by way of example, separate installation of a restoring spring can be dispensed with. Accordingly, on the one hand, installation of a component (push-in installation) is possible and, at the same time, a restoring endeavor as a result of the disk brake being released is automatically elastically assisted.

According to a development, the sleeve permits spring-like restoring assistance or impressing of a restoring effect for the purpose of generating a release movement for the release of a brake with a high-load-bearing and damping behavior, by the sleeve being manufactured from an elastomer with independent shape memory in order to generate a restoring function.

### BRIEF DESCRIPTION OF THE DRAWINGS

To further illustrate the basic principle, several embodiments are sketched symbolically in the drawing and will be described below. In the drawings:

FIG. 1 shows a disk brake with a guide device in a brake actuation position in partial section without a brake disk and in the maximally permissible wear state according to the embodiment,

FIG. 1a shows, for comparison, a disk brake as in FIG. 1 with new wearing parts (brake pads, illustrated without a brake disk),

FIG. 2 shows a partial section with a guide device sketched in enlarged form, as in FIG. 1,

FIG. 2a shows a guide section in a detail enlargement with clamping fixing, optimized in terms of push-in installation, between the sleeve and brake holder on the basis of the holding projection and collar with a schematically illustrated force flux,

FIG. 3 shows a sleeve in the undeformed state (production state),

FIG. 4 shows a side view of the sleeve in FIG. 3,

FIG. 5 shows a configuration of a sleeve with a radially folded bellows.

### DETAILED DESCRIPTION

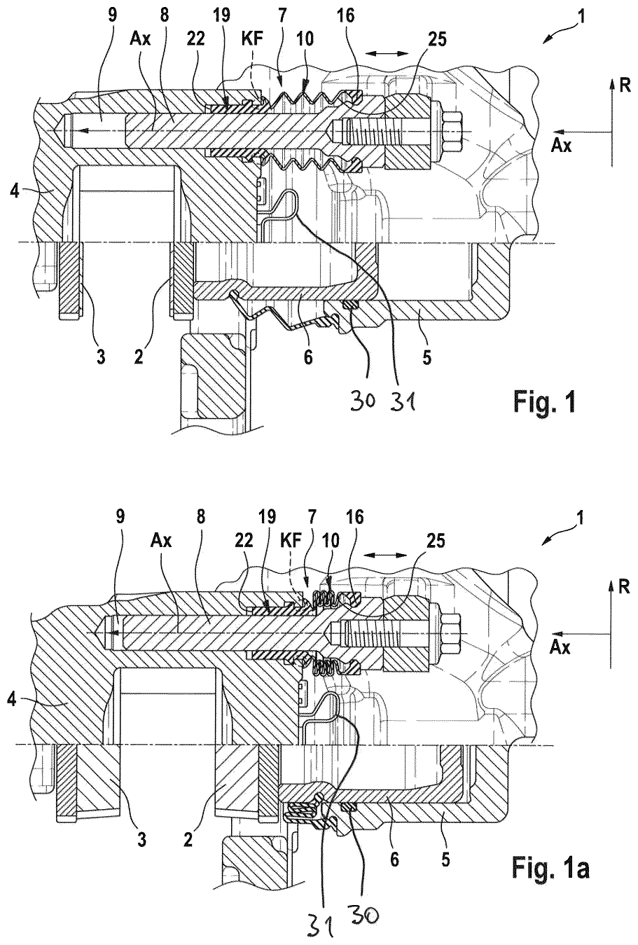

FIG. 1 shows a disk brake 1 of a motor vehicle disk brake system with brake linings 2, 3. In the vehicle driving operation or in the braking operation, a rotatably mounted brake disk, which is not illustrated for reasons of clarity, is located between the brake linings 2, 3. The disk brake 1 comprises a brake holder 4, which is mounted rotationally fixedly and fixed to the vehicle, and a brake caliper housing 5, which is guided in an axially displaceable manner relative to the brake holder 4. The brake caliper housing 5 has a hydraulic actuator or other actuator in combination comprising at least one axially displaceably guided transmission member 6, which may be designed, for example, as a hydraulic brake piston, for the direct actuation of a friction lining 2. An actuator drive of the motor vehicle disk brake 1 can be designed in principle electrically, hydraulically, pneumatically, magnetically or combined as desired, wherein, for the purpose of didactic simplification in FIGS. 1+2, a hydraulically actuated positioning actuator is sketched.

The brake holder 4 and the brake caliper housing 5 cooperate in a relatively displaceable manner relative to each other via a guide device 7 which comprises two bolts 8. The selected intersecting plane, as shown in FIGS. 1-3, shows, for simplified explanation, only one of identically designed bolt guides, since the other bolt guide is offset at a distance outside the drawing plane. The bolt 8 is fixed to or in the brake caliper housing 5, namely for example is screwed thereto, and is mounted at least partially in a bore 9 in the brake holder 4 (stator) in a manner guided relatively displaceably axially. The two bores 9 of the guide system may be designed identically in the same way as the bolts 8 and sleeves 10, 110 for streamlining purposes. A sleeve 10, 110 for example manufactured homogeneously from a shape memory elastomer is, on the one hand, fixed to the movable bolt 8 and, on the other hand, fixed to the brake holder 4. The sleeve 10, 110 comprises a bellows 18 and serves for flexibly sealing a length-variable gap or transition between the displaceable bolt 8 and its receptacle on/in the brake holder 4 which is fixed to the vehicle and also supports the brake linings 2, 3 in a rotationally fixed manner (brake stator). For the purpose of actuating the brake, a transmission member 6 is extended by the actuator out of the brake caliper housing 5 until the directly applied friction lining 2 first enters into frictional contact with the brake disk (not shown). The clamping of the brake disk following in the manner of a screw clamp, together with the indirectly applied friction lining 3, is carried out as a result of the reaction displacement of the brake caliper housing 5 counter to the axial direction Ax. A brake release process takes place in reverse. Accordingly, for braking and for releasing the motor vehicle disk brake in relation to the brake holder 4, the brake caliper housing 5 is guided by means of the guide device 7 in a rotationally fixed and axially displaceable manner. To illustrate the relative displaceability of the brake caliper housing 5 in relation to the brake holder 4, this is indicated in the figure with a double arrow.

The disk brake system 1 is explained by FIG. 1 by way of a sketch in a brake operating position, which is imaginary and correspondingly systemically position-proportional, under the assumption of a maximally permissible wearing part mass with regard to maximum friction lining wear and brake disk wear and therefore a maximally extended transmission means 6 (wearing parts with end-of-life/replacement required). As the wearing parts are in the maximally worn condition, the sleeve 10 is in its maximally elongated, extended operating condition. FIG. 1a shows, for the purpose of comparison, the accordingly unworn, position-corresponding arrangement only in connection with new, unworn wearing parts.

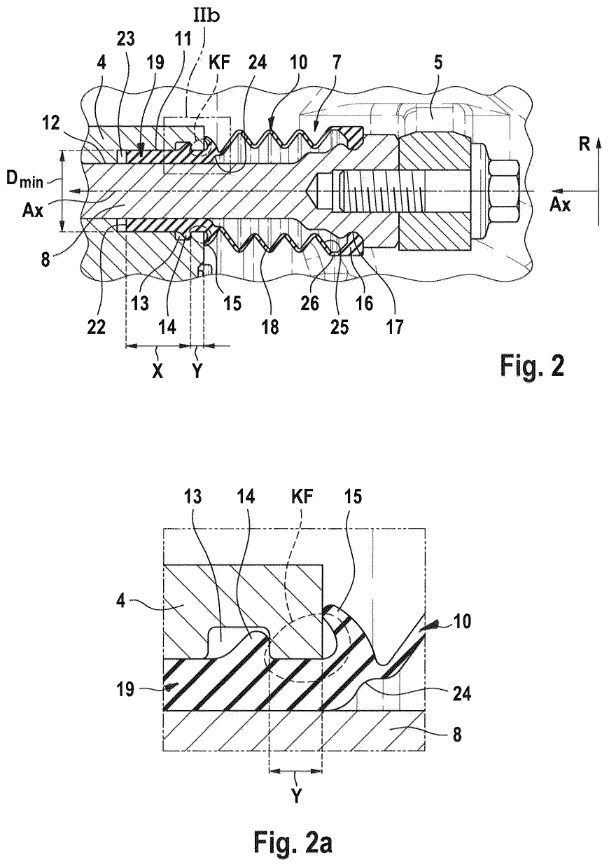

FIG. 2 shows a guide device 7, as shown in FIG. 1, in enlarged form. It can be seen here that the bore 9 in the brake holder 4 is designed as a simple stepped bore. A section 11 of the bore 9 of large diameter receives a guide section 19 of the sleeve 10. A section 12 of small diameter receives the bolt 8. The sleeve 10 has, on the one hand, a holding projection 14 which faces radially outward and penetrates a cavity 13 of the brake holder 4. Each sleeve 10, 110 has an elastic collar 15 which is offset at a distance Y from the holding projection 14 and sits on the outside of the brake holder 4 and seals the bore 9. The special interface configuration between the brake holder 4 and sleeve 10, 110 permits a special division of tasks and, by means of the force flux KF, permits a particularly easy-to-install snap-in fixing by the sleeve 10, 110 only undergoing elastic clamping forces over the partial length y, and without said holding clamping forces being guided over the partial length Y of the guide section 19. Accordingly, the guide section 19 is relieved of load at least over its proportional length X by the fixing force flux KF, and therefore the length X of the guide section 19 is substantially optimized for the sensing of the restoring task.

A bolt-side end of the sleeve 10, 110 can form a seat 16 for fixing to the bolt 8. For stabilization purposes, the seat 16 may be formed from sleeve material thickened annularly and/or in particular may have a ring element attached and/or inserted separately annularly or else in some other way for the purpose of stiffening the seat, and wherein said seat 16 facing radially inward engages in a circumferential groove 17 of the bolt 8, for example may be snapped into place elastomerically. The seat 16 and the guide section 19 are connected to each other via a bellows 18 which is deformable elastically in the manner of a harmonica. In a refinement, it is possible that the primary bellows attachment 26 to the seat 16 is beveled in a manner inclined radially inwardly in conical form as an insertion aid 25. With this or a comparably equivalently effective installation and insertion measure, it is made possible that an axially directed pushing-in process of a bolt 8 is effectively facilitated by, for example, a rounded or chamfered bolt end inserted with a certain inclination being able to slide to a certain extent automatically on an integrated and associated insertion slope of the sleeve 10, 110 gently in terms of components, without there needing to be concern about incorrect installation, threading into a fold or any bellows damage. Consequently, disturbances in the installation process or undesirable bolt tilting is structurally excluded or at least minimized by a special funnel-like bellows attachment.

Irrespective of this, or in a combination on both sides, as by way of example according to the exemplary embodiment, it is also possible, for the purpose of a developed installation, that an opening of a guide section 19 has, on the end side, a bolt centering section 24 which is configured by way of example in conical form in a funnel-like manner, and is successively narrowed.

The holding projection 14 and collar 15 or seat with ring element 16 fix the sleeve 10 in its intended position on the brake holder 4 or bolt 8. The bolt 8 is cylindrical with a constant diameter. In one embodiment, not shown, the bolt 8 may have flattened portions in its partial region opposite the guide portion 19.

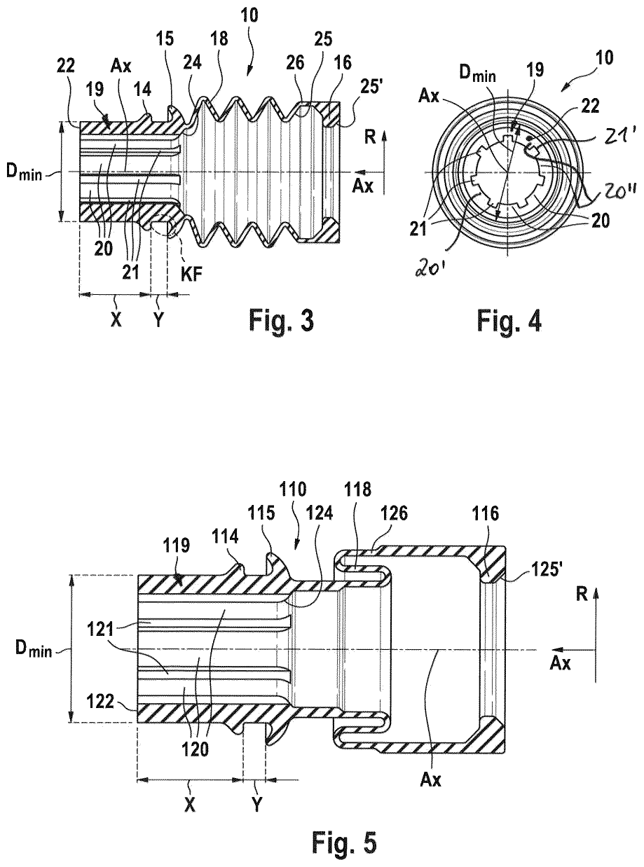

FIG. 3 shows a first embodiment of the sleeve 10 from FIG. 1 in a sectional illustration. The sleeve 10 has, on the radially inner side of the guide portion 19, a plurality of ribs 20 and grooves 21 arranged parallel to the axis of the bolt 8 from FIG. 1. The ribs 20 are directed at least with contactless flanks orthogonally perpendicular to the surface of the bolt 8, whereas bolt contact surfaces of the ribs 20 are parallel, smooth and flat with respect to the bolt 8 and, after the bolt has been pushed in with a homogeneously uniformly distributed surface pressure/homogeneously distributed preload, sit flat and uniformly on the bolt contact surface. The guide section 19 is smooth in relation to the bellows 18 over the length x substantially cylindrically and tubularly and is relatively thick-walled, without a sealing lip. In the region of the length y, the guide section 19 on its outside on the bellows side bears the collar 15 for the purpose of elastic contact, support or sealing on an end face of the brake holder 4, and the holding projection 14, which protrudes circumferentially at a distance and radially outward. At the other end of its bellows 18, the sleeve 10, 110, for fixing purposes, such as namely as a bolt-side interface, has a seat 16, which can have a reinforcing measure, such as a reinforcing element, ring element or the like.

FIG. 4 shows, in a side view, an end face of a sleeve 10, as per FIG. 3 and thus a proportional division between ribs 20 and grooves 21 in the guide section 19. It can therefore be seen here that the seven ribs 20 and seven grooves 21 alternate with one another. In this case, the mixed pairing is provided by a rib 20 and a groove 21 being paired together diametrically opposite each other.

FIG. 5 illustrates an alternative embodiment of a sleeve 110 in connection with an alternatively attached and configured bellows 118. This sleeve 110 differs in relation to the variant according to FIG. 3 for example in that the bellows 118 is arranged to a certain extent axially, for example in sections coiled parallel to the axis and layered in a meandering manner in the radial direction R for the purpose of elastic overlap between the seat 116 and guide section 119. Otherwise and for the interfaces or fixing to adjacent components and for the operation, what has been set forth previously in relation to the first sleeve variant also applies in principle.

The disk brake 1 is released in order to generate a release movement of the brake caliper housing 5 from the brake holder 4, the sleeve 10, 110 is designed such that, for example way of example, separate installation of a restoring spring can be dispensed with. Accordingly, on the one hand, installation of a component (push-in installation) is possible and, at the same time, a restoring endeavor as a result of the disk brake 1 being released is automatically elastically assisted.

According to a development, the sleeve 10, 110 permits spring-like restoring assistance or impressing of a restoring effect for the purpose of generating a release movement for the release of a brake with a high-load-bearing and damping behavior, by the sleeve 10, 110 being manufactured from an elastomer with independent shape memory in order to generate a restoring function.

According to another development, a bellows sleeve 10, 110 is configured structurally that the restoring function is generated by ribs 20, 120 of the sleeve 10, 110 with a defined axial stiffness of the elastomer, and wherein the elastic reverse deformation of the bellows sleeve 10, 110, which is clamped between the brake holder 4 and the brake caliper housing 5, is transmitted, when the brake is released, via a bolt 8 fixed to the housing.

According to another development, during operation the sleeve 10, 110 permits a circumferential wetting with sliding lubricant without a tendency to be wiped away, and a facilitated release movement (slight transition between static friction and sliding friction), if the ribs 20, 120 alternate with grooves 21, 121, the ribs 20, 120 lie evenly, smoothly, i.e., parallel, on the bolt 8 and are arranged parallel to the axis of the bolt 8. The grooves 20, 120 and ribs 21, 121 in the guide section 19, 119 correspond to one another (alternating on the circumference of the pitch circle), and a guiding function of the components (brake holder 4 for mounting the relatively displaceable brake caliper housing 5), where they are relatively displaceable axially to one another, and a bearing function are provided.

The release movement drive is generated by the sleeve 10, 110 in that the ribs 20, 120 bend elastically during actuation of the brake (as a result of displacement of the bolt), and therefore are to a certain extent preloaded spring-elastically by carry-along effects. When the disk brake 1 is released, micro-elastic bracing is dissipated, i.e., automatically released, by means of elastic reverse deformation (shape memory of the sleeve with guide section 19, 119), and thus a relative restoring movement via the bolts 8 to the brake caliper housing 5 is triggered, or at least assisted. A simple fit between ribs 20, 120, grooves 21, 121 and bolt diameter brings about an elastic dragging or preloading spring action in conjunction with a restoring spring action between the sleeve 10, 110 and bolt 8, without necessarily requiring a structuring of the sleeve, shaping or special bead constructions. This is because the relative bending of the ribs 20, 120 during braking, without the ribs 20, 120 having a filigree construction, which is fragile (durability and load-bearing capacity are limited with a filigree construction), nor with the ribs 20, 120 having to be produced with a complicated special profiling.

The embodiments have therefore recognized that (block) ribs which are elastically deformable by means of a shear force or transverse force and extend axially flatly and smoothly, with a comparatively high bolt load-bearing portion-in relation to an adjacent groove section (approximately comparable to an elastic restoring deformation behavior of profiled cleat parts of driven or braked vehicle tires positively engaging on a road) can be suitable, on the basis of elastic relaxation after relieving from load, for triggering an independent and automatic restoring effect.

Furthermore, by a suitable shaping and profiling in alternation (with, for example, a proportionally predominant rib portion in cooperating contact of the interface sections between the elastomeric sleeve 10, 110 and the metallic bolt 8), a circumferential distribution of sliding lubricant in the bolt guiding section can be ensured or at least assisted by an automated micro-pump effect as a result of a braking operation, without the risk that lubricant once introduced into the cavities (grooves) is successively completely removed, and it remains to a certain extent trapped in cavity reservoirs. At the same time, the efficiency of the brake guiding system during actuation and release is assisted by the lubrication efficiency/lubricant wetting. Alternating compression and relaxation as a result of application of a transverse force (circumferential force effect) with application of compression of the guide section 19, 119 of the bellows sleeve 10, 110 leads primarily to a continued and automatic micro-pump-like lubricant exchange between mutually adjacent longitudinal ribs and longitudinal grooves, and a metered elastic bellows deformation during actuation of the brake can additionally assist said pumping processes.

Ribs 20, 120 and grooves 21, 121 are arranged diametrically opposite one another in such a way that, as a result, excessive bolt play as well as a restricted load-bearing behavior are reliably excluded. An arrangement of pairs of grooves, or pairs of ribs, precisely diametrically opposite one another in pairs, is excluded. Vibrations between the components of the brake caliper housing 5 and the brake holder 4 can be reliably damped, in an development, if the sleeve 10, 110 has an odd number of grooves 20, 120 and ribs 21, 121. As a result, vibrations are damped via the sleeve guide and metallic rattling noises are avoided. The resulting damping behavior is reliable because of the odd number of ribs, i.e. for example independent of an angular positioning between the sleeve and the bore (i.e. also adjustment measures as required by DE 695 06 897 T2 are streamlined).

In order to assist the load-bearing capacity, i.e., (spring) stiffness stability, of a realized variant of a guiding system, an effective load-bearing proportion in favor of the ribs 20, 120 predominates. As a result, a predominant planar bolt contact via the system of ribs is made possible, i.e., surface pressure stress between the bolt surface and the sleeve 10, 110 is minimized by means of an increased positive load-bearing proportion. Conversely, the proportion which results from the grooves, in comparison to the rib proportion, can be represented by significantly less than 50% (cf. exemplary proportional distribution between ribs 20 and grooves 21, as can be seen with reference to FIG. 4).

For brake calipers of motor vehicle brakes, damping with sufficient stability is still obtained if the guide device has seven grooves 20, 120 and seven ribs 21, 121. For the purpose of reduction in play, in a refinement of a developed variant of a guide section 19, 119 a sleeve 10, 110 is defined in which no more than one single groove 21, 121 is arranged diametrically opposite a rib 20, 120, and vice versa.

Guiding of the brake caliper housing 5 relative to the brake holder 4 in a rib configuration which can be produced in a spring-elastically manner can be ensured, according to another development, if a rib contact surface is parallel, smooth and flat, whereas it is recommended that the rib flanks (i.e. surfaces of the ribs adjacent to rib contact surfaces without direct bolt support contact) be provided orthogonally perpendicular to the surface of the bolt.

A reliably fixed seat of the sleeve 10, 110 can be ensured, according to another advantageous development of the invention, if the bellows sleeve 10, 110 is fastened sealed with suitable interfaces respectively to bolt 8 and/or brake caliper housing 5 and/or brake holder 4. Furthermore, this configuration permits a dust- and liquid-tight separation from the ambient atmosphere (“dry interior”) of the bellows 18. The resulting bellows interior space between the sleeve and the bolt could alternatively be available as an additional lubricant reservoir.

A reliable seat of the sleeve 10, 110 on the bolt 8 can be ensured, according to another development, if the sleeve 10, 110 has a seat 16 with a separate or integrated reinforcement, such as for example a ring element. For example, a reinforcing means/ring element may be surrounded by a homogeneous elastomer material of the sleeve 10, 110. In this context, the seat 16 and reinforcing means/ring element can, for example, engage in a form-fitting manner in a circumferential cavity, such as in a radially inwardly or radially outwardly directed groove 17 of a bolt 8, a brake holder and/or a brake housing, and vice versa.

The fixing of the bellows sleeve 10, 110 with mixed direct and indirect guiding of the bolt is configured, according to a development, if the bore 9 in the brake holder 4 is in the form of a stepped bore having a section 11 of large diameter for indirectly receiving the bolt, i.e., receiving the guide section 19, 119 of the sleeve 10, 110, and having a section 12 of small diameter, which is designed for directly guiding the bolt in the brake holder 4. The proportionally offset arrangement when the sleeve 10, 110 is fixed to the brake holder 4 with an offset also contributes to the damping of the components.

According to another development, the sleeve 10, 110 is connectable to the brake holder 4 if the guide section 19, 119 of the sleeve 10, 110 has, on its outer circumference, a holding projection 14 penetrating a circumferential cavity 13 of the brake holder 4 in a form-fitting manner.

In a further developed refinement in terms of installation, the guide section 19, 119 of the sleeve 10, 110 circumferentially on the outer circumference starting from its free end 22; 122 and over a defined section length X is provided with a minimum outer diameter Dmin. At least the section length X of the minimum outer diameter Dmin is smooth substantially cylindrically or largely tubularly-without holding means. By means of this largely smooth tubular configuration, for example of the end section over the length X of the guide portion 19, 119, it is made possible for an insertion installation operation of the guide section 19, 119 into the bore 9 to thus be facilitated in a self-locating manner, to a certain extent “without restraint”. Therefore, the insertion can be begun in a correctly paired manner without force and with a comparatively low resistance, and without having to exert excessive installation pressure or deformation on the elastomeric sleeve 10, 110, and with a virtually planar seal on the outer circumference being made possible via the end section such that an axial sealing lip is streamlined. In other words, it is made possible by the interface impression illustrated, for example in connection with an elastomerically formed, flexible sleeve 10, 110, that a concentric assignment of the components to be paired is adjusted and is reliably maintained during the subsequent insertion and pressing-in operation, and without, for example, sensitive parts of a sleeve 10, 110 being able to be damaged in advance, for example, by sharp-edged drill hole shoulders or by means of a tilted pressing-in operation. The free end 22, 122 is configured without an axial sealing lip for it to be received inserted in the bore 9 with a clearance 23. With the axial sealing lip being streamlined. Thus, even with a maximally extended bellows (maximum wearing part size), there need be no concern about any contamination due to the axial sealing performance being reduced.

It should be added to the above that, a holding projection 14 is provided axially offset back by a length X from a free end of the guide portion 19, 119. The relative length X is comparatively significantly smaller than the above-explained section length Y. In summary, it is therefore made possible that an increased pressing-in resistance (pressing-in force requirement), which has to be applied for fixing the sleeve 10, 110 to the brake holder 4, has to be applied only chronologically after a successful pairing between the guide section 19, 119 and bore 9, which automated installation control is made possible, which can also be implemented by way of example on the basis of comparatively monitoring of a pressing-in force requirement. A force flux KF for fixing is closed over a short distance over the partial length Y, without the clamping forces necessary for the sealing fixing being guided over the length Y of the guide section 19, 119. The partial length X therefore remains relieved of the fixing force flux KF. Accordingly, a boundary condition for enabling a machine-supported, namely, automated, sleeve installation is thereby also proposed. Accordingly, a sleeve 10, 110—such as for example its special guide section 19, 119—allows a differentiation/separation of tasks with respect to installation and fixing tasks, on the one hand, and operational guiding and restoring tasks, on the other hand, and therefore the sections, features, means and sub-tasks provided for this purpose in each case largely separately and offset locally from one another can be provided in decoupled form.

In principle, the embodiments are suitable for all wheel brake applications, i.e., in an operation as a service disk brake arranged on a front axle and/or rear axle of a motor vehicle, and in use as a combined wheel brake which, in addition to a service brake function, additionally by way of example, integrates the electric parking brake function incl. parking brake actuator (actuating device) arranged in a currentlessly self-locking manner on or in the same wheel brake component.

Although a combination of hydraulic (service brake) actuator and electromechanical (parking brake) actuator appears conceivable in the case of the combined wheel brakes, the present is suitable for providing a brake standby position for so-called “dry brake” wheel brakes which, with wheel brake hydraulics being dispensed with, define a purely electrical brake positioning actuator, without a hydraulic actuator.

1. A motor vehicle disk brake comprising:
a brake caliper housing having a transmission member, with;
a brake holder, with a guide device for axially displaceably guiding the brake caliper housing on the brake holder;
a bolt as a component of the guide device, wherein the bolt is fixed to the brake caliper housing and is provided in a manner guided and mounted axially displaceably in a bore in the brake holder via a guide section;
a sleeve with a bellows for sealing the gap between the bolt and brake holder, wherein the sleeve has a guide section which is fixed to the holder and acts on the bolt in a force-fitting manner, and
wherein the sleeve is arranged between the brake holder and the brake caliper housing in such that the sleeve via the guide section is automatically restored to an original position by relative displacement between the brake caliper housing and the brake holder.

2. The motor vehicle disk brake as claimed in claim 1, wherein the sleeve is manufactured from elastomer to automatically generate a restoring force.

3. The motor vehicle disk brake as claimed in claim 2, wherein the restoring force is transmitted to the bolt by ribs via the guide section.

4. The motor vehicle disk brake as claimed in claim 2, wherein the sleeve has a defined spring stiffness of the elastomer.

5. The motor vehicle disk brake as claimed in claim 1, wherein the guide section defines a continuous surface contact between at least one rib and the bolt over a length.

6. The motor vehicle disk brake as claimed in claim 1, wherein the sleeve is clamped elastically deformably with a defined spring stiffness between the bolt and brake holder in order to generate an additional restoring force portion on the basis of a defined bellows section, and wherein a bellows which is preferably folded in a zigzag-shaped manner permits a defined elastic reverse deformation of the bellows.

7. The motor vehicle disk brake as claimed in claim 1, wherein the guide section has alternately arranged ribs and grooves, wherein the ribs sit smoothly and directed in parallel on a circumferential surface of the bolt, and the ribs and grooves each extend parallel to an axis of the bolt.

8. The motor vehicle disk brake as claimed in claim 7, wherein the ribs and grooves of the sleeve are configured in such a way that the bolt support thereof in the alternation between brake actuation and brake release alternately causes pressure and suction via a micro deformation and micro reverse deformation during an automatic lubricant pump operation, to permit at least one of lubricated bolt contact, lubricant distribution and lubricant circulation.

9. The motor vehicle disk brake as claimed in claim 7, wherein no more than one groove is arranged diametrically opposite each rib, and vice versa.

10. The motor vehicle disk brake as claimed claim 7, wherein one groove is placed diametrically opposite each rib, said groove being arranged centrally between two flanking rib sections.

11. The motor vehicle disk brake as claimed in claim 7, wherein with reference to the support on the bolt, an areal proportion of load-bearing ribs predominates, compared to a proportion of non-load-bearing grooves.

12. The motor vehicle disk brake as claimed in claim 7, wherein the guide section of the sleeve has an odd number of grooves and an odd number of ribs.

13. The motor vehicle disk brake as claimed in claim 7, wherein the guide section of the sleeve has seven grooves and seven ribs.

14. The motor vehicle disk brake as claimed in claim 7, wherein the ribs are perpendicular in a direction facing the surface of the bolt.

15. The motor vehicle disk brake as claimed in claim 1, wherein the sleeve has at least one seat with at least one reinforcing means for at least one of fixing and sealing purposes.

16. The motor vehicle disk brake as claimed in claim 13, wherein the seat together with reinforcing means is annular, and placed in a circumferential groove of the bolt.

17. The motor vehicle disk brake as claimed in claim 1, wherein bore in the brake holder is provided as a stepped bore having a first section of large diameter for the proportional indirect guiding of the bolt via the guide section of the sleeve, and wherein a second section of small diameter is provided, which serves for the proportional and direct guiding of the bolt in the brake holder.

18. The motor vehicle disk brake as claimed in claim 1, wherein the guide section of the sleeve has, on its radially outer circumference, a holding projection for form-fitting engagement in a cavity of the brake holder.

19. The motor vehicle disk brake as claimed in claim 1, wherein the guide section of the sleeve is formed smoothly on the front side and circumferentially on its outer circumference starting from its free end and also over a defined section length, with a minimum outer diameter Dmin without a holding projection, in a manner appropriate for plugging-in installation.

20. The motor vehicle disk brake as claimed in claim 1, wherein the guide section is in the form of a radially outwardly directed cylindrical sealing surface over a section length circumferentially in a manner free from undercuts such that sealing is provided for simple plugging-in and latching installation fixing in the brake holder.

21. The motor vehicle disk brake as claimed in claim 1, wherein the holding projection of the guide section, starting from its a free end, is provided offset back by a length such that plugging-in fixing of the bellows sleeve over the length by via elastic bracing is provided.

22. The motor vehicle disk brake as claimed in claim 1, wherein the guide section is provided in such a way that a length is larger than a length.

23. The motor vehicle disk brake as claimed in claim 1, wherein a free end of the sleeve is formed without a sealing lip, and is received in the bore with a clearance.

24. The motor vehicle disk brake as claimed in claim 1, wherein clamping with an internal force flux for the purpose of fixing the sleeve in the brake holder by clamping is closed over an insertion length between the holding projection and collar such that the guide section is provided without a clamping force flux over an insertion length.

25. The motor vehicle disk brake as claimed in claim 1, wherein the sleeve in the region of a mouth of a guide section has an integrated bolt centering section.

26. The motor vehicle disk brake as claimed in claim 1, wherein the sleeve at least one of at and adjacent to a seat on the sleeve has an integrated insertion aid.

27. A sleeve for a motor vehicle disk brake comprising:
a seat,
a bellows and
a guide section which is fixed to a holder and acts on a bolt in a force-fitting manner, and
wherein the sleeve is arranged between the brake holder and a brake caliper housing such that the sleeve via the guide section is automatically restored to an original position by relative displacement between the brake caliper housing and the brake holder.
